(19) United States
(12) Patent Application Publication
(10) Pub. No.: US 2013/0048668 A1
(43) Pub. Date: Feb. 28, 2013

(54) Pressure sensing liquid dispensing system

(71) Applicant: John Patrick Osborne, Chicago, IL (US)

(72) Inventor: John Patrick Osborne, Chicago, IL (US)

(21) Appl. No.: 12/660,177

(22) Filed: Feb. 22, 2010

(51) Int. Cl. B67D 1/08; F16K 31/02

(52) U.S. Cl. 222/1; 222/14; 251/129.15; 222/54; 222/61

(57) ABSTRACT

An automated liquid dispensing system for dispensing a pressurized liquid through a feed line includes a pressure sensing device having a sensing component provided in the feed line for sensing the pressure of the liquid. A pour control center is provided in the feed line. A smart director is electrically connected to the pressure sensing device and to the pour control center for continually and selectively actuating the pour control center in response to input from the sensing device.

### CROSS-REFERENCE TO RELATED APPLICATION

None.

### BACKGROUND OF THE INVENTION

The liquid beer delivery apparatus industry enjoys a long history. For example, In 1691, an article in the London Gazette mentioned John Lofting. Lofting held a patent for a fire engine. He also has “projected a very useful engine for starting of beer, and other liquors which will draw from 20 to 30 barrels an hour, which are completely fixed with brass joints and screws at reasonable rates”.

Serving draught beer from pressurized containers began in the early 20^{th} century. Artificial carbonation was introduced in the United Kingdom in 1936 by Watney. Watney's experimental pasteurised beer Red Barrel did not become popular in the U.K. until the late 1950s. It did, however, become the preferred method in the rest of Europe, where it is known by such terms as en pression. The method of serving beer under pressure then spread to the rest of the world. By the early 1970s, most draught beer was beer served under pressure.

Today, beer served from kegs is still an important piece of Western culture, particularly for pubs or concessions. Millions have been known to stand in long lines at sporting events and concerts awaiting a frothy cup of beer. Where many customers are present, known beer delivery methods can provide a number of challenges. For example, the beer can become warm. Further, the beer can run out, without warning, before all of the customers have been served. Additionally, overpouring can cause thousands to millions of dollars loss in revenue for vendors.

Faced with these problems in the industry, John Osborne undertook to revolutionize the known beer delivery systems to provide improved speed of delivery, quality assurance, and increased profits. His efforts began by attempting to standardize the pour size of a beer using an automated delivery system that adjusted a predetermined pour time using a system pressure detection method as discussed in U.S. Pat. No. 5,730,323 to Osborne. An apparatus for controllably delivering a liquid under pressure from a supply to a first location is provided. The apparatus includes a first structure operable for a predetermined first time interval to cause flow of a first predetermined quantity of liquid at a first pressure from the supply at the first location. A second structure is provided for sensing the pressure of the liquid. If the pressure of the liquid is not at the first pressure, a compensatory of delivery of the liquid from the supply to the first location occurs each time the first structure is operated for the first time interval. The first structure can be operated for different time intervals corresponding to different size containers. The container size can be selected by a user of the system.

This system offered a partial solution to one of the problems faced by vendors, but an improved solution to the pour size was still needed. Further, the beer could still become warm. In addition, the beer could still run out, without warning, before all of the customers have been served.

Moreover, the greatest losses associated with known dispensing mechanisms are due to waste and pilferage. Millions of dollars in annual losses in revenue are still being incurred by vendors due to inefficiency of the dispensing mechanism, imperfect pours, and pilferage.

For example, many pubs and concessions untap their beer lines at night in an effort to prevent pilferage. The beer remaining in the lines turns to foam overnight. Often times, over 100 ft of beer per line is lost each night by untapping the lines. In fact, approximately 20% of yearly losses are due to untapping lines at night.

Further, it is often difficult to track the number of cups sold against the revenue turned in by an operator of a known dispensing machine. However, the number of ounces of beer per keg is a known quantity. Therefore, it is possible to determine yearly loss retroactively by comparing the number of kegs purchased per year to the total yearly revenue for beer. The discrepancies between the number of kegs purchased and the yearly revenue using the known dispensing machines is often astounding.

It can be seen from the foregoing that the need exists for an improved beverage dispenser that overcomes the above problems while also improving the speed of service to the consumer.

### SUMMARY OF THE INVENTION

In accordance with the principles of the present invention an automated liquid dispensing system for dispensing a pressurized liquid through a feed line is provided. The system includes a pressure sensing device having a sensing component provided in the feed line for sensing the pressure of the liquid. A pour control center is provided in the feed line. A smart director is electrically connected to the pressure sensing device and to the pour control center for continually and selectively actuating the pour control center in response to input from the sensing device.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a front perspective view of an embodiment of an automated liquid dispensing system constructed in accordance with the principles of the present invention.

FIG. 2 illustrates a detailed view of one embodiment of an automated liquid dispensing system constructed in accordance with the principles of the present invention.

FIG. 3 illustrates a detailed view of a valve assembly constructed in accordance with the principles of the present invention.

FIG. 4 illustrates a rear perspective view of the embodiment of FIG. 1.

FIG. 5 illustrates a schematic of another embodiment of a liquid dispensing system constructed in accordance with the principles of the present invention.

FIG. 6 illustrates a schematic of yet another embodiment of a liquid dispensing system constructed in accordance with the principles of the present invention.

### DETAILED DESCRIPTION OF THE INVENTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows will refer to the invention as depicted in the drawings.

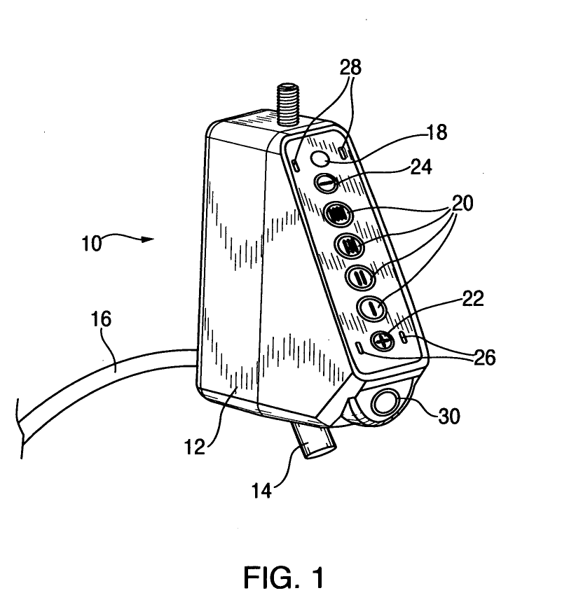

An embodiment of in accordance with the principles of the present invention is shown in FIG. 1. An automated liquid dispensing system is shown generally at 10. The dispensing system 10 includes an external housing 12. The external housing 12 can be sealed to prevent theft. The housing 12 can be of any suitable size, shape, color, and texture to create a desired appearance of the dispensing system 10. A dispenser 14 is provided. Liquid can enter the housing 12 of the dispensing system 10 through a feed line 16, and exits the housing 12 through the dispenser 14. The housing 12 further includes a face plate 18. The face plate includes multiple size buttons, such as the four buttons 22 illustrated in FIG. 1.

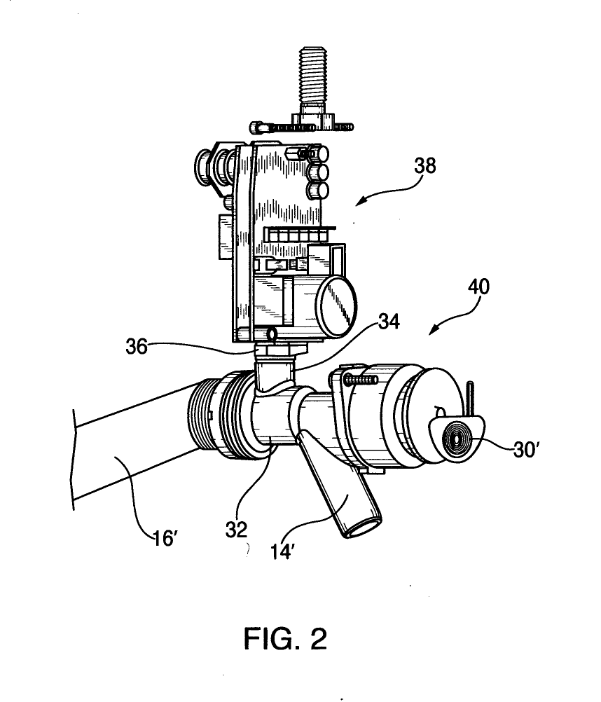

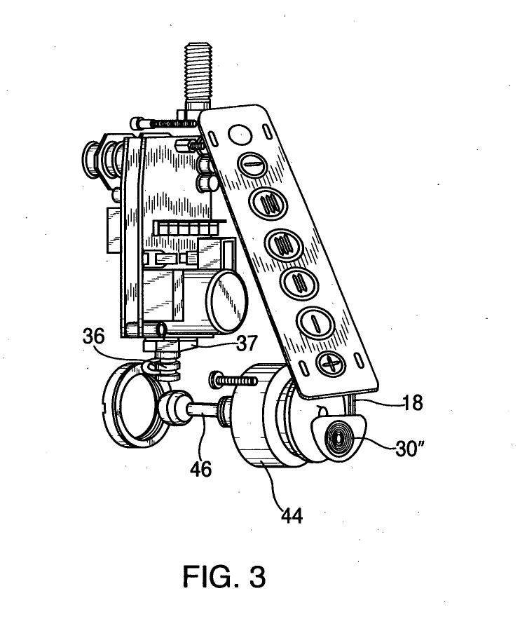

An add dab button 22 is also provided. The add dab button allows an operator of the dispensing system 10 to complete add an addition ⅓ ounce of beer to put a fresh head on a beer. A stop button 24 is also provided. The stop button 24 can be used to cancel the pour and close a valve system 42 illustrated in FIGS. 2 and 3. LEDs or indicator lights 26 and 28 can be provided to indicate system information via color or blinking. The LEDs can indicate information, such as, for example, system online, system offline, clean mode, and calibrate.

A bump switch 30 is also provided. The bump switch 30 allows a one handed operation of the dispensing system 10. The bump switch 30 is activated by placing the cup or glass up to the switch 30 and pushing the switch 30 with the cup or glass. When the cup or glass reaches the switch 30 the dispenser 14 will be in the correct position with respect to the glass or cup that a pour can be initiated. Thus, there is no need to push a button with one hand while holding the cup or glass with the other hand.

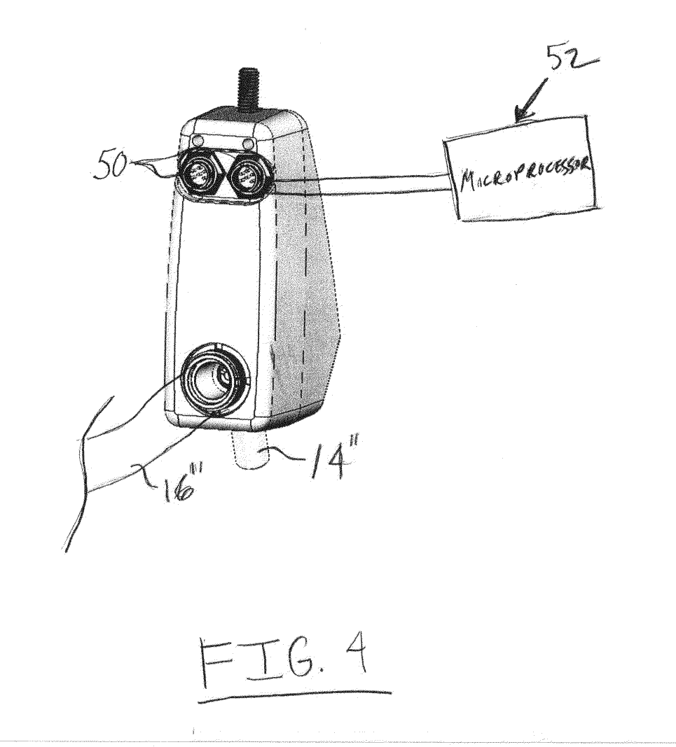

As illustrated in FIGS. 2 and 3, the bump switch 30′, 30″ is connected to the system 10. The switch 30′, 30″ can be directly or wirelessly connected to the system 10, such as the direct connection 48 illustrated in FIG. 3. The bump switch 30 provides feedback data to the system 10 regarding the number of cups poured. When this feedback is combined with feedback regarding the number of cups of specific sizes, then a determination can be made as to the amount of liquid dispensed by the system 10. The determination as to the amount of liquid dispensed by the system 10 can be made by an internal microprocessor, shown generally at 38 or by an external microprocessor or remote computer 52, illustrated in FIG. 4.

A pour control center, shown generally at 40 is provided for selectively actuating the flow of liquid through the dispenser 14. A pressure sensor housing 34 connected to the dispenser 14 via the connector 32 permits a continuous pressure sensor reading of a liquid in the feed line 16′ as it flows through the connector 32 to the dispenser 14′. A pressure sensor 36 sits above the pressure sensor housing 34 and extends into the pressure sensing housing 34, as illustrated in FIG. 3. The pressure sensor 36 is connected to a smart director, such as internal microprocessor 38 shown in FIG. 2 or an external microprocessor, such as external microprocessor 52 illustrated in FIG. 4. The pressure sensor 36 determines the pressure applied at the valve. The value for the pressure determined at the valve is used by the microprocessor 38 or 52 to achieve a perfect pour. One example of a suitable pressure sensor 36 is a MSP100 0-100 psi pressure sensor, although any pressure sensor that determines the pressure at the valve in order to correctly time each pour is suitable for the system 10 in accordance with the principles of the present invention.

As illustrated in FIG. 3, the pour control center, or pour controller 40 includes a solenoid 44. A plunger 46 is connected to the solenoid 44, and moves in and out of the solenoid 44 to selectively stop the flow of liquid into the connector 32 illustrated in FIG. 2. A temperature sensor 37 can also be provided. The temperature sensor 37 can be connected, for example, to a metal ring of the pressure sensor 36.

FIG. 4 illustrates connectors 50 provided on the back of the dispensing system 10. The connectors permit external connections to power, other dispenser systems, a remote microprocessor, such as microprocessor 52, or any other desired electrical connection. Suitable connectors 50, can permit, for example, a 24 volt connection. Paired wiring can be provided for the connectors 50, permitting dispensing systems 10 to be daisy chained together for communication and power. Further, all of the dispensing units 10 daisy chained together can be networked into a global network, such that all stores or stadiums could be tied to a central location where management and inventory can be controlled at the central location.

Further, when kegs are married together, the pressure sensor 36 automatically updates the pressure of the system, from which the smart director 74 or microprocessor 60 determines the number of ounces of beer available to the system. Where a number of dispensers 10 are daisy chained together, the director 74 or microprocessor 60 updates information regarding the number of ounces available to each of the dispensing systems 10 when kegs are married together via the pressure sensor 36. The smart director 74 or internal microprocessor 60 can be preprogrammed to operate the system 10.

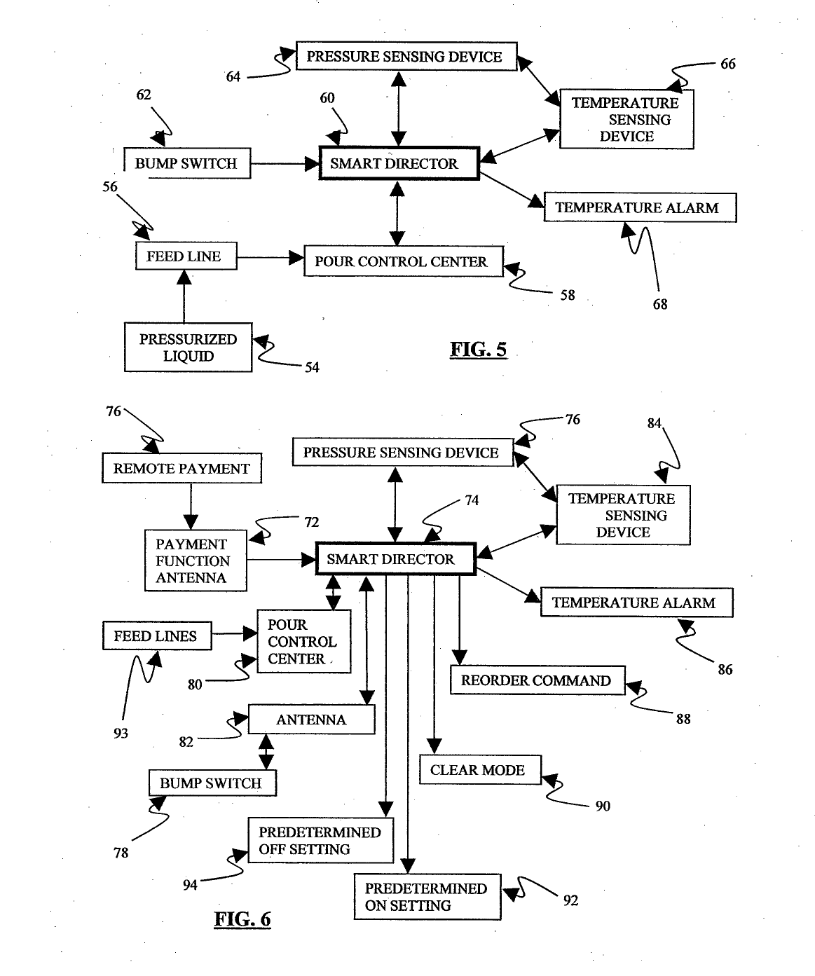

Turning now to FIG. 5, a schematic representation of the dispensing system 10 is provided. Pressurized liquid 54 is connected to a feed line 56 of a dispensing system 10. The feed line 58 is connected to a pour control center, or pour controller 58. The pour control center 58 is connected to a smart director, such as an internal microprocessor 60. When a bump switch 62 is activated, the smart director 60 begins sampling data from a pressure sensing device 64. Data from a temperature sensing device 66 can also be sampled, if desired. If the temperature rises above a desired preset, then the smart director 60 can activate a temperature alarm 68.

As illustrated in FIG. 6, the dispensing system 10 can include a remote payment center 70. The remote payment center 70 would eliminate the need to involve cash in the transaction to assure that a payment is received for each pour. Here, smart cards can be scanned, for example, and a wireless signal transmitted from the payment center 70 scanner to a payment center antenna 72 on the rear of the system housing 12 (not shown). A smart director 74, such as a remote computer, is connected via RF (radio frequency) to the payment antenna 72. The smart director 74 then gathers continuous information from a pressure sensing device 76 connected to the director 74 and can selectively activate a bump switch 78 to permit selective activation of a pour control center 80 when pressure is applied to the switch 78 with a glass or cup. Activation of the bump switch 78 can occur via a signal from the smart director 74 in response to a payment notification from the RF antenna 72, or in response to a manual activation of the bump switch 78. The director 74 then collects data from the switch 78 regarding the number of pours initiated, which equals the number of switch activations. Data from the bump switch 78 to the director 74 can be received wirelessly, such as by antenna 82. The director 74 continually updates the time to pour to the pour control center 80 as it receives pressure data from the sensing device 76. The data regarding the number of pours collected from the bump switch 78 reduces pilferage, as it allows the unit to track how many cups were sold, how many ounces were poured, and the time of each pour. With the dispensing system 10, accountability is increased substantially by automatically tracking the sales and eliminating the need to involve cash in beer purchase transactions. Further, even where cash is not eliminated from the transaction, the dispensing system 10 provides data as to the number of cups sold and provides a way to determine if the correct amount of cash is turned in by a vendor given the number of cups sold.

Further, a temperature sensing device 84 can ensure the quality of the liquid dispensed by the system 10. For example, if the temperature sensed by the temperature sensing device 84 is too warm, the director 74 can set off a temperature alarm 86. In addition, the director 74 initiates a reorder command 88 if the pressure reading from the pressure sensing device 76 falls to a specified level. The pour control center 80 can also be directed to remain open via a clean mode command 90 so that the system feed lines 93 can be cleaned. Predetermined on and off settings 92, 94 allow the system 10 to automatically turn on and complete a final pour then shut down at the times set and stored in the director 74. In addition, the off setting 94 allows the system 10 to be turned off at night without untapping the lines, thereby eliminating loss from the lines sitting overnight after untapping a dispensing system.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. An automated liquid dispensing system for dispensing a pressurized liquid through a feed line comprising:
a pressure sensing device having a sensing component provided in the feed line for sensing the pressure of the liquid;
a pour control center provided in the feed line; and
a smart director electrically connected to the pressure sensing device and to the pour control center, the smart director being adapted and constructed to continually and selectively actuate the pour control center in response to input from the sensing device.

2. An automated liquid dispensing system as claimed in claim 1, further comprising a temperature sensing device connected to the smart director and to the pressure sensing device.

3. An automated liquid dispensing system as claimed in claim 1, wherein the smart director determines a loss of pressure from the pressure sensing device and institutes a reorder command.

4. An automated liquid dispensing system as claimed in claim 2, wherein the smart director determines a rise in a temperature from the temperature sensing device and sets off a temperature alarm if the temperature rises above a preset temperature.

5. An automated liquid dispensing system as claimed in claim 1, further comprising a bump switch connected to the smart director.

6. An automated liquid dispensing system as claimed in claim 1, further comprising a housing having indicator lights for notifying a user of the system of a status of the system.

7. An automated liquid dispensing system as claimed in claim 1, further comprising a clean mode, wherein the smart director retains the pour control center in an open position to facilitate cleaning of the feed line.

8. An automated liquid dispensing system as claimed in claim 5, further comprising a remote payment system wirelessly connected to the smart director and to the bump switch, wherein the smart director actuates the bump switch when the remote payment system indicates that valid payment has been made.

9. An automated liquid dispensing system as claimed in claim 1, further comprising predetermined on and off operational settings programmed into the smart director for completing a last pour at a predetermined time and then shutting down the automated system.

10. An automated liquid dispensing system as claimed in claim 1, wherein the smart director comprises an internal microprocessor.

11. An automated liquid dispensing system as claimed in claim 1, wherein the smart director comprises a remote computer.

12. An automated liquid dispensing system as claimed in claim 11, further comprising an antenna for transmitting system data to the computer at predetermined intervals.

13. An automated liquid dispensing system as claimed in claim 12, wherein the data includes the number of pours for each of the pour sizes of the system.

14. A method for automating delivery of pressurized beer via a feed line comprising the steps of:
providing a pour controller in the feed line for selectively actuating the delivery of beer;
operatively connecting the pour controller to a microprocessor;
providing a pressure sensor in the feed line, operatively connected to the microprocessor; and
directing the pour controller via the microprocessor to deliver the beer for a pour time determined by continuous output from the pressure sensor to the microprocessor.

15. A method according to claim 14, further comprising the step of:
providing a temperature sensor operatively connected to the microprocessor.

16. A method according to claim 15, further comprising the step of providing a bump switch operatively connected to the microprocessor.

17. A method according to claim 15, further comprising the step of
providing indicator lights on an external housing and operatively connected to the microprocessor.

18. A valve assembly for automating the delivery of a pressurized liquid in a feed line comprising:
a solenoid valve; and
a plunger connected to the solenoid valve provided in the feed line, wherein the solenoid valve is selectively actuated by a microprocessor operatively connected to the solenoid valve.

19. A liquid dispensing system for a pressurized liquid comprising:
a pressure and temperature sensor for generating a temperature and pressure output;
a smart director, electrically connected to the pressure and temperature sensor, for converting the pressure and temperature output of the pressure and temperature sensor into a pour amount, the pour amount including a pour time, when temperature conditions are correct, to achieve delivery of a correct serving of the pressurized liquid; and
a pour control center, including a valve assembly, for selectively dispensing the pressurized liquid for the pour time determined by the smart director.

20. A fully automated beer dispensing system for delivering beer via a feed line comprising:
a payment function antenna for receiving a signal from a payment receipt center;
a smart director operatively connected to the payment function antenna and to a switch provided on a front of a housing of the system;
means for continually sensing temperature and pressure of beer in the feed line of the system and for continually determining a pour time for each activation of the switch, electrically connected to the smart director.
